(19) United States
(12) Patent Application Publication
(10) Pub. No.: US 2004/0009313 A1
(43) Pub. Date: Jan. 15, 2004

(54) Hot melt container

(76) Inventors: James E. Jackson, Burlington, VT (US); Thomas James Macaulay Bentley, Little Ouseburn (GB); Martin Gunson, Halifax (GB)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/196,346

(22) Filed: Jul. 15, 2002

(51) Int. Cl. F16L 1/00

(52) U.S. Cl. 428/34.1; 264/330

(57) ABSTRACT

Apparatus and method of manufacture therefor for containing heated substances without cover deformation. The apparatus has a container bottom and a lid member, where the container bottom has integrated within it a support structure such that when the lid member engages the container bottom, the support structure provides additional support to the lid member. The integrated structural support can be provided substantially at the area of the container bottom where the lid member, when attached, has relatively weak support at a predetermined temperature range.

### TECHNICAL FIELD

The present invention is directed to containers for heated liquids, and more particularly, to an apparatus and method for containing heated liquids in a manner that the radiating heat does not degrade the structural integrity of a container including cover.

### BACKGROUND INFORMATION

Many manufacturing processes, such as soap base manufacturing, for example, involve processing heated material (e.g., soap base) while the material is still hot, for example at temperatures in the range of 155° F. to 170° F. For example, existing processes for packaging hot melt soap base involve a conveyor line process in which hot melt soap containers are moved along and filled with the hot soap base. In a conventional exemplary process, once the trays are filled, they are run through a 50 foot cooling tunnel on a conveyor. However, since the hot soap material is very resistant to cooling, the soap base remains liquid even after the in-line cooling process. Therefore, it is necessary to cure the plastic containers from 2 to 4 days at ambient temperature. After such time the soap is removed from the trays by line workers, placed into a shrink wrap machine, wrapped and sealed. This process is time, labor and overhead intensive. It also increases the price of a product that is mature in the market place and thus requires maximum production efficiency.

An alternative method that could be much more efficient and cost effective could theoretically be achieved by simply packing the soap base in its container. Such a method would include filling a container, sealing it on line, running it through a cooling tunnel to bring the temperature down from, for example 170° F. to 120° F., packing the container into a corrugated box, and placing it on a pallet for shipment. However, when attempting to utilize this method using conventional containers, it was discovered that they simply could not support the temperature ranges of the material (e.g. 155° F. to 170° F.). As a result, the covered containers collapsed, leaking hot soap and making it difficult to handle. For example, the corners of containers often collapsed under the heat and hot soap spilled out on the conveyor or in the shipping box. When containers collapsed, the structural integrity was compromised, thus making the finished product unsuitable for distribution to retail stores. Further, containers collapsed in the corners and along the sides, making it impossible to apply their lids on the line. Finally, containers collapsed in the middle of the container if one attempted to stack the container, spilling hot soap over the entire box.

### SUMMARY OF THE INVENTION

According to an exemplary embodiment of the present invention, an apparatus and method are provided for containing heated substances without deformation of a container cover. The exemplary apparatus has a container bottom and a lid member, and the container bottom has integrated within it a support structure such that when the lid member is put into place and sits upon the container bottom, the support structure provides additional support to the lid member. According to an exemplary embodiment of the present invention, the support structure allows for sealing a container containing hot melt during the manufacturing process without deformation of the container lid. In an exemplary embodiment, the integrated structural support element(s) are provided substantially at the area(s) of the container bottom where the lid member, when attached, has relatively weak vertical support at a predetermined temperature range.

### BRIEF DESCRIPTION OF THE DRAWINGS

FIG. 1 depicts a perspective view of an exemplary container according to an embodiment of the present invention;

FIG. 2 depicts a perspective view of the exemplary container of FIG. 1 without the lid;

FIG. 3 depicts a top view of the exemplary container of FIG. 2;

FIG. 4 depicts a bottom view of the exemplary container of FIG. 2; and

FIGS. 5-8 depict various views and exemplary dimensions of an alternate exemplary embodiment of the present invention.

### DETAILED DESCRIPTION

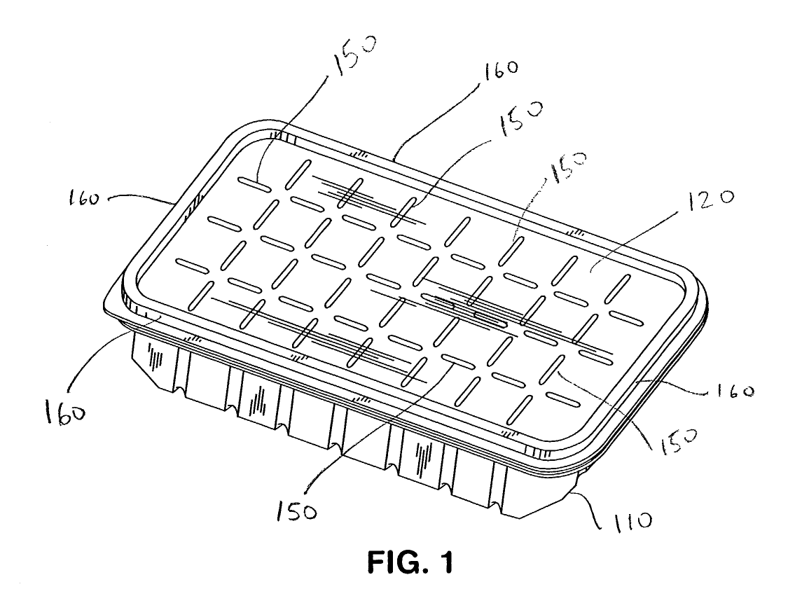

FIG. 1 depicts an exemplary embodiment of the present invention. With reference thereto, the device includes a container bottom 110 and a lid member 120.

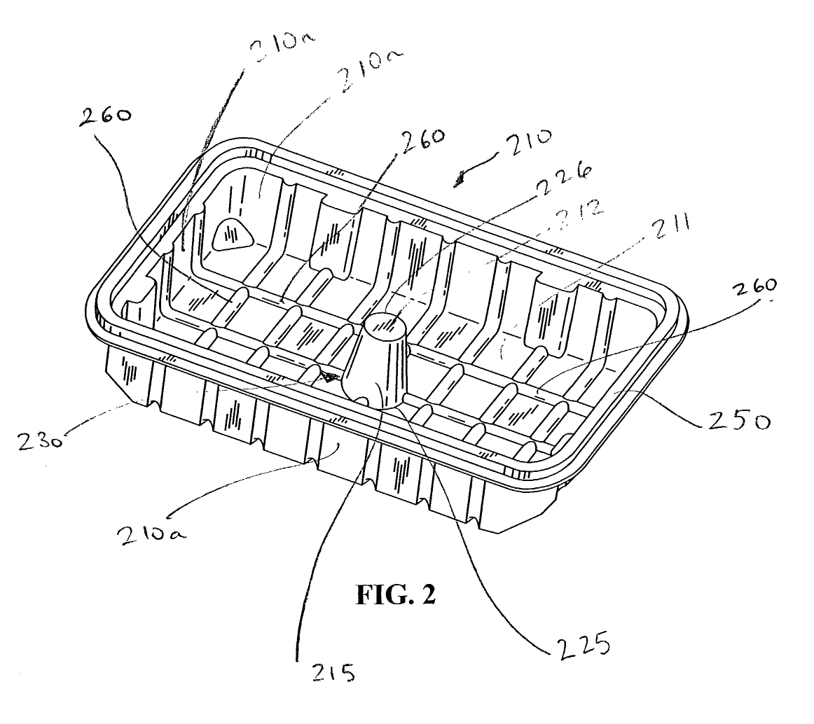

FIG. 2 depicts the container bottom without the lid; the internal structures will be next described with reference thereto. The container bottom 210 includes side walls 210a and a bottom surface 211. According to an exemplary embodiment of the present invention, bottom surface 211 has integrated within it a support structure 230, for example integrally formed as a raised portion of the container bottom 210 extending from the bottom surface 211 to the top of the container bottom (e.g., rising to the horizontal plane formed by the top edge of side walls 210a). Support structure 230 being formed, for example, as an indentation in the bottom surface 211 of the container bottom 210, has no bottom surface itself, but has a top surface 212.

Alternatively, support structure 230 can include a bottom surface if the manufacturing process provides therefor (e.g., support structure 230 can be formed as solid member integrally formed as part of container bottom 210). The top surface 212 of the support structure 230 can have any desired shape, including, for example, the same shape made by the junction of the substantially vertical surfaces 215 of the support structure 230 with the bottom surface 211 (in the structure of FIG. 2 this intersection is a circle 225). For example, in an exemplary embodiment of the present invention, the support structure is depicted as a partial conical structure whose bottom circle 225 has a greater radius than the circle 226 which comprises its top surface 212.

The exemplary support structure 230 depicted in FIG. 2 is a hollow mesa type structure with a continuous substantially vertical surface 215 (functioning as its walls) and a top circular surface 212. As mentioned above, in general, the support structure 230 can have a top surface 212 of any desired shape. Support structure 230 also could have any number of substantially vertical surfaces 215, and they could be at a variety of angles with the bottom surface 211 of the container bottom 210. Further, there can be any number of support structures 230 provided in the container bottom 210 as may be needed to support the lid member 120 (all references herein to the lid member are with reference to FIG. 1) at a particular temperature. All this will depend, of course, inter alia, upon the structural properties of the lid member 120, the composition and the contemplated operating range of temperatures. As an example, for hot packaging of soap melt base at operating temperatures in the range of, for example, 140° F. to 180° F., the singular central support structure depicted in the Figures is fully adequate for the depicted container. In other contexts, depending on the size of the container, multiple support structures 230 can be used as necessary or desired to provide adequate support for the lid member 120 when the container is sealed once filled with hot melt.

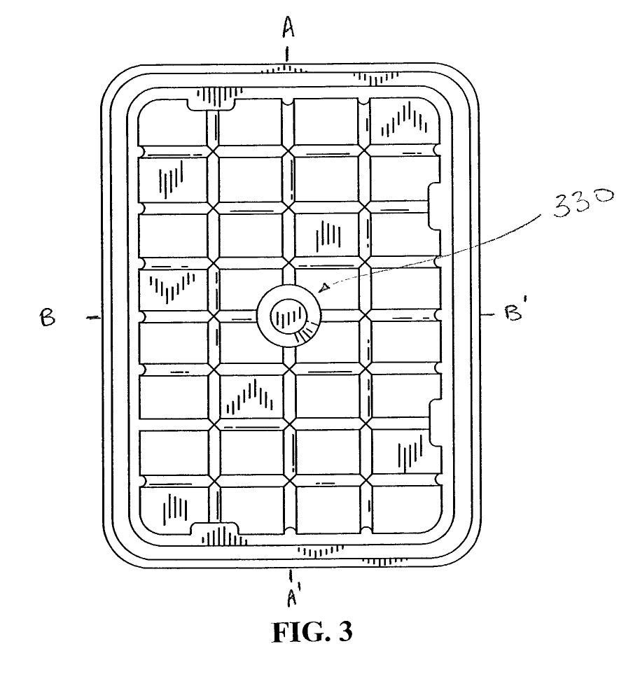

The placement of the support structure 230 or structures in relation to the container bottom 210 also can vary and may be dependent upon the application. In general, because the support structure 230 is intended to preclude deformation of the lid member 120 due to the temperature of the contained substance, the positioning of the support structure is, for example, optimally at the point (or points if multiple support structures are used) of weakest vertical support, which in the exemplary embodiment of FIG. 3 is located at the centroid of the container bottom 210, where lines running through points A-A′ and B-B′ would intersect.

The apparatus according to an embodiment of the present invention can be made from any suitable material known in the art, and in an exemplary embodiment would be made from polyvinylchloride (PVC) or other economical polymer. In such an exemplary embodiment, the apparatus can be made from, for example, 8 millimeter PVC.

In the exemplary embodiment depicted in FIG. 2, the container bottom 210 could have dimensions of approximately 200 mm width, 155 mm depth, and 35 mm height, and a corresponding lid member 120 is adapted, with appropriate dimensions, so as to removably sealably close with the container bottom. Theses exemplary dimensions are taken, in the case of the container bottom 210, along the inside cavity or containing space. In an exemplary embodiment such as depicted in FIG. 2, a support structure could be about 35 mm high, have a base circle of diameter about 25 mm and a top surface of diameter about 15 mm.

In the exemplary embodiment depicted in FIG. 2, the top edges 250 of the container bottom 210 contain a conventional flange capable of releasably engaging the lid member 120. In such an exemplary embodiment, the lid member 120 may thus be removably attached to the top edges of the container bottom 210. Other suitable structures for releasably engaging the lid member 120 to container bottom 210 can be used as are, or as may be, known in the art.

In an exemplary embodiment, the container bottom 210 may contain ridges extending horizontally and vertically across its bottom surface 211 for additional support, design, coordinate fixation, registration of the cooled substance for further processing, or other purposes. Such ridges are generally for ornamental purposes (although depending upon the composition of the bottom container and its thickness, some ridging may be necessary for structural strength) and can be varied or omitted as desired without affecting the utility of the improved container according to an embodiment of the present invention.

In an exemplary embodiment, the lid member 120 may also contain ridges extending horizontally and/or vertically across it, for similar design as well as functional reasons.

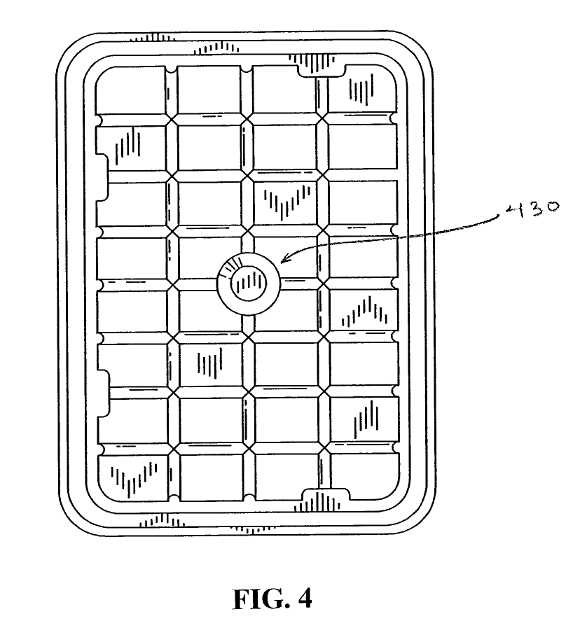

FIGS. 3 and 4 provide top and bottom views of the container bottom depicted in FIG. 2. As can be seen, the support structure 330, 430 is located at the centroid of the bottom surface of the container.

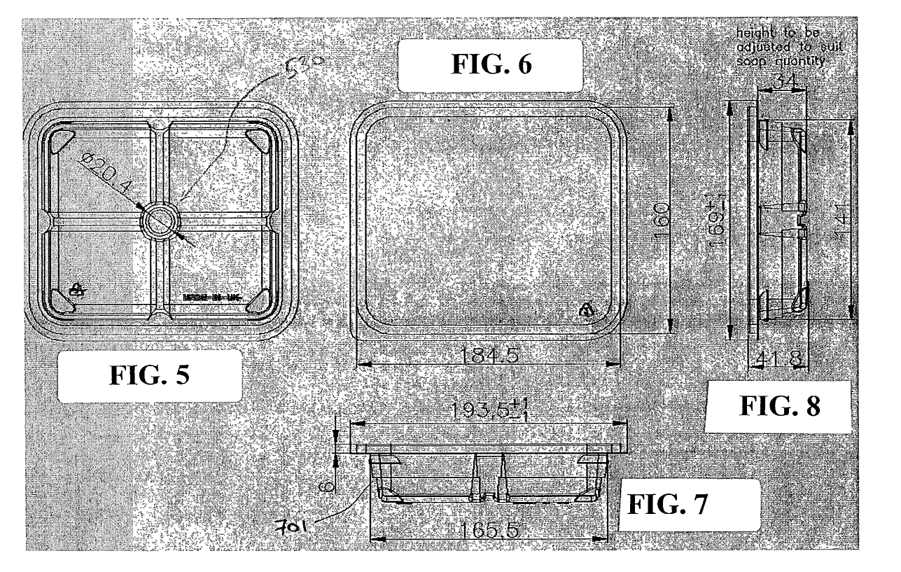

FIGS. 5-8 depict a second exemplary embodiment of the present invention. FIG. 5 depicts the container bottom, with a similar central support structure as depicted in the exemplary embodiment of FIG. 2. However, in the embodiment depicted in FIG. 5, the bottom surface of the container bottom does not contain the same number of ridges as the embodiment depicted in FIG. 2. In fact, the ridges are constructed so as to create four divisions in the bottom surface of the container bottom, as opposed to, for example, the 32 separate divisions illustrated in the embodiment depicted in FIGS. 2 through 4. In general, any number of divisions could be created as ornamentation and other considerations and tastes are addressed.

In the exemplary embodiment of the invention depicted in FIG. 5, the conic support structure has a bottom diameter of about 20.4 mm. FIG. 6 depicts a lid member for the exemplary embodiment depicted in FIG. 5, and the lid member has no horizontal and/or vertical ridges, in contrast to the lid member 120 depicted in FIG. 1. The dimensions of the lid member depicted in FIG. 6 are about 184.5 mm width and about 160 mm depth. Again, these dimensions are taken from the outer flange, or wall, of the elevated ridge structure of the lid member to the corresponding opposite outer flange or wall.

FIG. 7 is a side view of the container bottom as shown in FIG. 5 with the lid of FIG. 6, and it also depicts exemplary dimensions. An additional feature of this exemplary embodiment is also visible in the side views of FIGS. 7 and 8, namely a two-level structure on the side walls of the container bottom. As can be seen with reference to FIG. 7, there is a line running across the side wall of the container bottom approximately midway between the top and the bottom surfaces, indicated as 701 in FIG. 7. This two layer structuring can be, like the ridge structures in the container bottom surface discussed above, primarily ornamental but may have other purposes as well. The exemplary dimensions of the bottom container, as depicted in FIG. 7 are a depth of about 165.5 mm taken across the top tier of the two tier structure, and as shown in FIG. 8, about 141 mm of depth. The height of the elevated ridge structure is about 6 mm in elevation. Additionally, as shown in FIG. 7 the width taken along the maximum width dimension of the lid (from flange edge to opposite flange edge) is about 193.5 mm.

Finally, FIG. 8 depicts the side view of the depth dimension of FIG. 6 and indicates that the maximum depth of the lid is about 169 mm. As can be seen from FIG. 8 as well, the height of the container bottom is about 34 mm from the bottom surface of the container bottom to the plane at a height approximately equal to that of the top of the support structure 530 (see FIG. 5) and the height of the container bottom measured from its bottom surface to the top to the plane of the uppermost surface of the raised groove structure is about 41.8 mm. These dimensions for a second exemplary embodiment are only provided as examples and in no way limit or restrict the various possible embodiments of the present invention whether in absolute magnitudes of dimensions or in relative magnitudes thereof.

Due to the support structure(s) of the container of the present invention, and due to the fact that the container bottom is provided so as to sealably removably lock with the container bottom, hot melt substances can be packaged without waiting for any cool-down curing time. This advantageously allows minimal handling and maximum output through the production line. Line efficiency is thus achieved by placing containers on a line, filling them to capacity, lidding them, labeling them, cooling them down slightly and placing them in a box or other final large scale packaging. In an exemplary embodiment, the placing being one on top of another for 12 to 24 containers per corrugate shipper. In an exemplary embodiment, these goals are easily achieved with a container for hot soap at from about 120° F. to 170° F.

It is understood that numerous variations of the present invention, as to dimension, placement of support structures, material composition and other attributes will be obvious to those skilled in the art. All of these variations are intended to be included in the invention, whose scope is therefore to be determined with reference to the following claims.

What is claimed is:

1. An apparatus for containing a heated substance comprising:
a container bottom; and
a lid member engagable with the container bottom;
wherein the container bottom includes an integrally formed support structure extending from a bottom surface of the container bottom to substantially a top surface of the container bottom.

2. The apparatus of claim 1, wherein when the lid member engages the container bottom, the support structure provides support to the lid member.

3. The apparatus of claim 2, wherein the container bottom and lid member are formed of polyvinylchloride.

4. The apparatus of claim 2, wherein a top surface of the support structure engages a bottom surface of the lid member.

5. The apparatus of claim 1, wherein the a top edge of the container bottom engages the lid member.

6. The apparatus of claim 2, wherein the support structure is frustoconical.

7. The apparatus of claim 3 wherein the lid member releasably engages the top edge container bottom.

8. The apparatus of claim 2, wherein the heated substance to be contained includes one of a soap and a soap base.

9. The apparatus of claim 2, wherein the support structure includes a hollow mesa type structure.

10. The apparatus of claim 2, where the support structure is provided at substantially an area of the container bottom where the lid member has relatively weak support at a predetermined temperature range.

11. A method of manufacturing a container for containing heated substances, comprising:
providing a container bottom and a lid member; and
providing a structural support integrally formed with the container bottom, where the structural support is provided substantially at an area of the container bottom where the lid member, when attached, has relatively weak support at a predetermined temperature range.

12. The method of claim 11, wherein the container bottom and lid member are constructed of polyvinylchloride.

13. The method of claim 11 where the integrated structural support is formed as indentations in a bottom surface of the container bottom.

14. The method of claim 11, wherein a top surface of the container bottom contains a flange capable of engaging the lid member.

15. The method of claim 11, wherein the lid member may be removably attached to the container bottom.

16. The method of claim 11, where the heated substance is soap or soap base, and the predetermined temperature is approximately 155° F.

17. The method of claim 11, wherein the structural supports include more than one structural support capable of supporting the lid member.

18. A method for producing a molded product, comprising:
providing a mold base having a structural support member extending from a bottom surface of the mold base to substantially a top surface of the mold base;
filling the mold base with a heated substance to be molded, the heated substance being in a substantially liquid state; and
sealing the mold base while the heated substance remains in the substantially liquid state.

19. The method of claim 18, wherein the substance includes one of a soap and a soap base.

20. The method of claim 18, where, while the substance to be molded is still in the liquid state, the mold base is labelled, cooled down slightly, and placed in a box or other final large scale packaging.

21. The method of claim 20, where the mold bases are placed one on top of another in shipping containers.
